(19) United States
(12) Patent Application Publication
(10) Pub. No.: US 2007/0095179 A1
(43) Pub. Date: May 3, 2007

(54) Systems and methods for cutting woven blinds

(76) Inventors: Michael J. McCarty, Rancho Santa Margarita, CA (US); Frank A. Gutierrez, Holly Glen, CA (US)

Correspondence Address: Robert D. Fish;Rutan & Tucker, LLP, 611 ANTON BLVD, SUITE 1400, COSTA MESA, CA, 92626, US

(21) Appl. No.: 11/366,848

(22) Filed: Mar. 1, 2006

Related U.S. Application Data
(60) Provisional application No. 60/731,630, filed on Oct. 28, 2005.

(51) Int. Cl. B26D 1/00

(52) U.S. Cl. 83/13; 83/651

(57) ABSTRACT

A cutter system to cut woven blinds. The cutter system includes a table, a rotary cutter having a circular knife blade, a carriage coupled to the table to support the rotary cutter, a movable holding bar configured to hold a woven work piece against the table and counteract a distortion force to the woven work piece, a linear actuator mechanism operatively coupled to the rotary cutter, and wherein the linear actuator mechanism is capable of driving the rotary cutter to travel in one degree of freedom across the table along the carriage.

### CROSS-REFERENCE TO RELATED APPLICATIONS

This application is the U.S. Utility patent application for U.S. Provisional Patent Application No. 60/731,630, filed on Oct. 28, 2005, which is hereby incorporated by reference in its entirety.

### FIELD OF THE INVENTION

The field of the invention is cutting systems for window blinds, specifically cutting systems for woven blinds.

### BACKGROUND

Various types of window blinds are currently known. Some of them include Venetian blinds, miniblinds, vertical blinds, and woven blinds.

Venetian blinds typically have horizontal slats that are usually made from aluminum and may also be made of plastic or wood. The slats may be slightly curved and connected by cords and twill tape. They can be opened, closed, opened at an angle or pulled up to the top of the window. These blinds are very versatile, can be used in any room and are available in many colors. The slats close tightly, providing privacy when desired.

Miniblinds are generally venetian blinds with very narrow slats, either ½ or 1 inch wide. They may be aluminum or PVC and come in a wide array of colors.

Vertical blinds are generally blinds with vertically running slats. The PVC or metal slats hang from a track across the top of the window or door. The slats may either be connected at the bottom with a chain or cord, or simply hung loose.

Unlike the styles described above, woven blinds typically do not have slats that open or close. The slats in woven blinds are generally very narrow and woven together. Narrow spaces between the slats filter sunlight. In general, more light is admitted by pulling a draw string and rolling the blind up toward the top of the window.

Among various types of woven material suitable for making woven blinds, woven woods is one of the fastest growing product in window coverings today. Blinds made of woven woods are very organic, yet fashion-forward choice that compliments today's more eclectic home décor styles. Woven woods blinds offer a more natural transition between the outdoors and an interior environment.

Woven woods are typically crafted in a wide range of materials from around the globe, and comprised of materials such as all natural and renewable jute, bamboo, reeds, grasses, other natural fibers and textured materials woven together.

In manufacturing woven woods blinds, a sheet of woven woods are typically cut to desired width using a pair of pneumatic shears. Cutting woven woods requires visual alignment to make sure that the edges of the woven woods are substantially parallel with vertically running woven fibers that typically intersect with horizontally running natural wooden slats. This cutting process is time-consuming, labor intensive, and poses increased occupational hazard to users operating pneumatic shears.

Thus, there is still a need for improvements to methods and systems of cutting woven blinds that is relatively safer to operate, relatively less time-consuming, minimizes un-aligned cuts, and minimizes cracking, crushing, or chipping woven reeds.

All referenced patents, applications and literatures are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

The present invention provides apparatus, systems, and methods to cut woven blinds. Among the many different possibilities contemplated, the system includes a table, a rotary cutter having a circular knife blade, a carriage coupled to the table to support the rotary cutter, a movable holding bar configured to hold a woven work piece against the table, a linear actuator mechanism operatively coupled to the rotary cutter, and wherein the linear actuator mechanism is capable of driving the rotary cutter to travel in one degree of freedom across the table along the carriage.

Further, it is contemplated that the woven work piece is a woven blind having substantially parallel elements coupled to each other by retaining threads such that the blind has sufficient flexibility to allow distortion of the blind into a trapezoidal structure from a rectangular structure by displacement of parallel elements from each other. These parallel elements are contemplated to include typical woven blinds material such as jute, wood, bamboo, rattan, reeds, fabric, and vinyl.

The system is further contemplated to cut a sheet material. This sheet material is contemplated to have longitudinal elements coupled and substantially parallel to each other in ways to allow sufficient flexibility for multi-directional movement of each longitudinal element relative to each other. This limited multi-directional movement of longitudinal elements allows contortion of the sheet material due to a cutting force, from a substantially flat rectangular configuration to other configurations such as wavy, trapezoidal, and twisted configurations.

Contemplated sheet material comprises of no more than 70 longitudinal elements woven together for every inch in a vertical direction. Example of sheet materials include woven blinds, and example of the longitudinal elements include jute, wood, bamboo, rattan, reeds, fabric, and vinyl.

It is contemplated that the rotary cutter (also referred to as a rotary cutting tool) travels across a section of the table and is believed to generate and exert a force on the woven blind in operation, and wherein the contemplated holding bar is configured to counteract the force generated by the rotary cutter. The holding bar is contemplated to have a holding surface and a holding force capable of biasing the work piece (e.g., woven blinds, sheet materials) against the table in a greater or equal counterforce to counteract the cutting force and to prevent or minimize contortion. Counteracting the force by the holding bar is also contemplated to secure each individual slat relative to each other, this prevents otherwise uneven cut, and prevents shifting of slats relative to each other.

Contemplated rotary cutter operatively couples to a blade sharpener, and a blade cooling device.

In other preferred embodiments, the holding bar (also referred to as retaining bar) has a holding surface with a length configured to substantially bias against at least an intended cutting length of the woven blind. Also, the holding surface is contemplated to have a sufficient width capable of counteracting the cutting force placed on each longitudinal element. Another preferred embodiment provides a holding surface with a width of at least three centimeters. The movable holding bar is contemplated to be driven by at least one of electric force, hydraulic force, manual force, and pneumatic force.

Further, contemplated holding surface is capable of holding the woven blind in position to complete a full cut by the cutting tool to create a straight edge with less than 5% frayed edges, more preferably less than 2%, most preferably less than 1%.

In other preferred embodiments, the linear actuator mechanism is a screw drive mechanism having a long rotatable, threaded rod disposed parallel to the carriage, and wherein rotation of the threaded rod moves the rotary cutter in a distal direction by engaging with the treaded rod with a mating block of the rotary cutter.

In still further preferred embodiments, the linear actuator mechanism is a belt drive mechanism having a movable belt disposed parallel to the carriage, and wherein movement of the belt moves the rotary cutter in a distal direction.

The system preferably includes a measuring ruler coupled to the table, a fence guide that is adjustably movable in a direction perpendicular to a longitudinal axis of the carriage, a laser alignment guide to produce a visible line of light on the woven blinds, wherein the line of light is parallel to the carriage, and a trough coupled to the table and located underneath a path of the rotary cutter to catch trimmings of the woven blinds.

The system preferably includes a microprocessor capable of receiving a user input to automatically operate the rotary cutter, the holding bar, and the linear actuator to cut woven blinds.

Another aspect of the invention is directed to methods of cutting a woven blind to desired width using the contemplated system as described above. In the contemplated method, a user enters into the microprocessor data regarding desired cutting length; the user enters a command for cutting to begin; the microprocessor turns on the rotary cutter; the microprocessor initiates movement of the holding bar in a downward direction to hold the woven blind against the table; the microprocessor turns on the linear actuator mechanism to move the rotary cutter in a distal direction traveling a distance longer or equal to the desired cutting length; the microprocessor turns off the linear actuator and turns off the rotary cutter after cutting is performed; and the microprocessor initiates movement of the holding bar in an upward direction to disengage the holding surface from the woven blind.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of woven blind cutting system according to an aspect of the inventive subject matter.

### DETAILED DESCRIPTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that the spirit of the invention also intends to encompass.

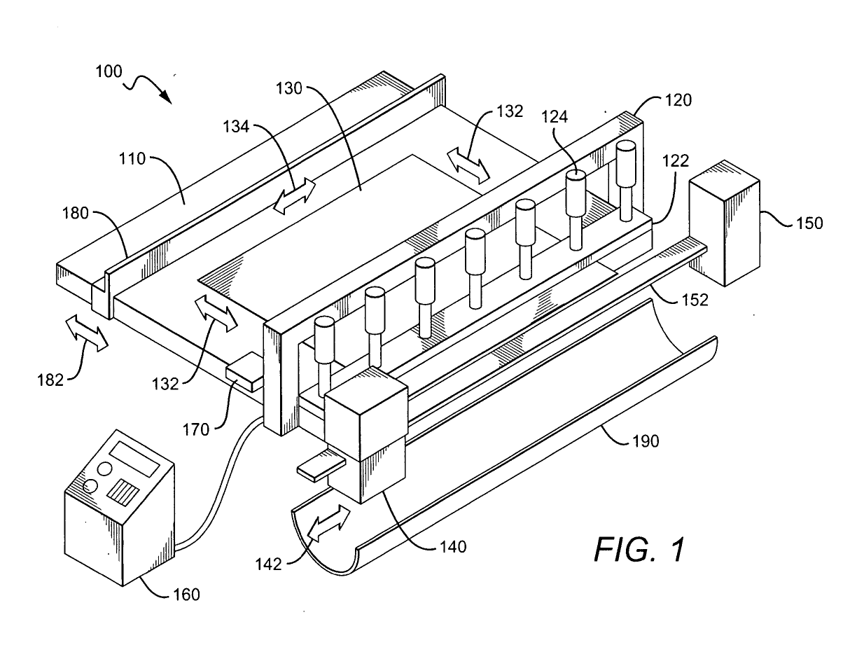

FIG. 1 generally depicts a system 100 for cutting sheet materials, or specifically, woven blinds. The system in FIG. 1 includes a table 110, a retaining mechanism 120, a rotary cutter 140, a linear actuator mechanism 150, a control panel 160, a laser alignment device 170, a fence guide 180, and a trough 190.

Table 110 has a flat, leveled, working surface, four edges, and is supported by supporting legs. Supporting legs can be secured to the floor to minimize vibration and movement. Table 1110 can have length measuring notations, or rulers, disposed across the tabletop to facilitate measuring of woven blinds 130 placed on the tabletop. Preferred size of tabletop is at least eight feet by ten feet.

Retaining mechanism 120 generally comprises of a bridge structure and a holding bar 122. Bridge structure spans across the top of the table and acts as a structural support to which the holding bar 122 is operatively coupled. Holding bar 122 is movably coupled to the bridge structure through a plurality of pneumatic pistons 124. Holding bar 122 is capable of moving bi-directionally. Through actuation of the pneumatic pistons 124, holding bar 122 can move in a downward direction to bias against the tabletop, thus sandwiching woven blinds 130 placed in between the tabletop and the holding bar 122. In contemplated embodiments, retaining mechanism 120 preferably has at least two pneumatic pistons 124, more preferably at least six, most preferably at least 12. Holding bar 122 can also move in an upward direction away from the tabletop to release pressure placed on the tabletop. Positions of the holding bar 122 can be independently controlled by a user via a master control panel 160. Alternatively, movement of holding bar 122 can be semi-automatically or automatically controlled by a microprocessor.

As used herein, the term “woven blinds” refers to sheet material comprised of slats (also referred to as longitudinal elements/parallel elements) and textured materials woven together. These slats can include synthetic, natural and renewable materials such as vinyl, PVC, cane, bamboo, jute, reeds, and grasses. The slats may be either whole or split pieces of natural fibrous materials. The slats do not open or close, but the small gaps between the pieces of slats admit filtered light to pass through. Slats in the contemplated woven blinds are arranged horizontally (arrow 132) and are parallel to each other. Contemplated woven blinds is comprised of 1-100 slats per inch in a vertical direction (arrow 134), more preferably, 5-80 slats, most preferably, 10-50 slats. Each slat can be semi-rigid, allowing minimum or no flexibility along its length. The contemplated cutting system cuts woven blind 130 to adjust the width of the woven blind, which is equivalent to shortening the length of the slats.

Due to the flexible nature of the woven blinds, a rotating cutter blade is prone to distort a sheet of woven blind in many ways if the woven blind was not sufficiently secured to the table during cutting. For example, when rotating cutter blade engages with an unsecured, substantially flat, rectangular woven blind, the force of the spinning blade can cause the flat configuration to slightly distort into a wavy configuration. Likewise, a general trapezoidal shape can result from slight displacements of the slats with respect to each other. Each slat can be displaced, with respect to each other, in directions 132 and 134, and in parallel as well as diagonal directions. Such capability for relative movements amongst the slats can result in distortions that can lead to uneven cutting, and/or frayed edges.

To minimize these undesirable effects and to produce a relative straight, aligned, and uniform cut, holding surface of holding bar 122 has a preferred length capable of evenly applying pressure along a desired cutting length of the of woven blind 130. The holding surface is defined as the underside of the holding bar 122 which directly contacts the tabletop or woven blind 130 when holding bar 122 is moved downwardly to bias against the table. Although holding bar 122 is shown in FIG. 1 to have a continuous and rectangular holding surface from one end of the bar to the other end, one skilled in the art would recognize that holding surface can have any suitable configuration capable of holding woven blinds 130 in place during cutting. Preferably, the holding surface has a length that is a least 80% of the desired cutting length of the woven blind 130, more preferably at least 90%, most preferably at least 100%. The intended goal is to apply sufficient pressure across sufficient points of contact along the desired cutting length to counteract any forces distorting the generally flat, rectangular shape of woven blind 130 during cutting. Another intended goal is to secure a sufficient percentage of slats to the tabletop as each slat lies on the table, parallel to arrow 132. Preferably, the holding surface has a length that directly contacts thus secures a least 80% of the slats in the woven blind 130, more preferably at least 90%, most preferably at least 100%.

Another key feature of contemplated embodiments is that holding surface also has sufficient width to apply pressure to woven blind 130 for counteracting any distortion forces in directions 132 and 134. It is further contemplated that holding surface has a width of at least one centimeter, more preferably at least 3 centimeters, most preferably at least 10 centimeters.

In other preferred embodiments, the holding surface is positioned adjacent an edge of the table 110 and has a length substantially equal to the length of the edge of the table. It is further contemplated that holding surface has a length of at least 80% of the length of the edge of the table, more preferably at least 90%, most preferably at least 100%.

Holding bar 122 secures woven blind 130 to the table, and directly holds woven blind in an area close to the intended cutting path. In other words, retainer mechanism 120 is designed such that the holding surface presses down substantially next to, and along, the intended cutting path of the cutter 140. To describe it in a different way, the distance between the edge of the holding surface (while in a downward position) and the freshly cut edge of woven blind 130 is preferably at least 10 centimeters, more preferably at least 6 centimeters, most preferably at least 1 centimeter.

Besides using pneumatic pistons 124 as shown, holding bar 122 can be actuated by other known actuator mechanisms where the actuation may be done mechanically, manually, electronically, or hydraulically.

Retaining mechanism 120 is preferably made of metal, most preferably aluminum, and can have other structural configurations so long as the intended goal of securing woven blinds 130 onto a tabletop is achieved. Holding surface of the holding bar 122 preferably includes soft, elastomeric material to facilitate holding of the woven blind 130. Preferred material is soft rubber to hold material of varying shapes.

As shown further in FIG. 1, a rotary cutter 140 is operatively coupled to the table. The rotary cutter 140 travels bi-directionally along an edge of table 110 via a track, or carriage (not shown). Traveling directions of the rotary cutter is noted by arrow 142. Preferably, a circular knife blade is used instead of a toothed saw blade. Toothed saw blades tend to create undesirable frayed edges on woven blinds. Rotary cutter 140 may be selected from known commercially available rotary cutters and can have user-adjustable speeds. Speed of the rotary cutter can be manually or automatically set for different types of woven blinds. A suitable cutter system is Eastman® Cardinal® Knife Saw, class 548, 220V with a Teflon® or PTFE-coated knife blade. Additionally, a blade sharpening device and a blade cooling device can be coupled to the rotary cutter 140 for their intended purposes. The blade sharpening device can include a manually actuated lever with a sharpening stone to manually engage the sharpening stone to circular knife blade.

Rotary cutter 140 is operatively coupled to a linear actuator 150 having a track 152. Various types of commercially available linear actuators can be used. One key feature of the contemplated linear actuator 150 is the capability to prevent over-traveling. Sensors can be provided to detect traveling speed and distance. And contemplated linear actuator 150 can be designed to automatically decrease the traveling speed of rotary cutter 140 along the carriage, as cutter 140 gets close to a stop. Preferably, traveling speed begins to reduce when the cutting tool is within five centimeter to 100 centimeter range from a desired stopping position, more preferably five centimeter to 50 centimeter range, most preferably 5 centimeter to 20 centimeter range. Optionally, a maximum travel distance/position is programmed so that linear actuator 150 would stop traveling when rotary cutter 140 reaches the pre-set maximum travel distance/position.

Suitable linear actuators include belt driven Rapidtrak® linear actuator by Thomson®. Preferred linear actuator has a stepper motor and encoder.

Another suitable linear actuator is a screw drive actuator with variable speed motor. In a screw drive actuator, a long rotating rod having spiral threads is disposed along track 152 and cooperates with a mating block of the rotary cutter 140 to move the rotary cutter 140 bi-directionally 142. Direction of movement 142 depends on rotational direction of the rotating rod. There are many known screw drive actuators commercially available and one of ordinary skill in the art would appreciate the type of screw drive actuators suitable for this application.

Although FIG. 1 illustrates rotary cutter 140 as positioned to travel along the border of table 110, rotary cutter 140 can also be arranged to travel across a middle portion of table 110. The intended goal is to have a rotary cutter 140 that travels from a proximal position to a distal position while the work piece (e.g., woven blinds) remains stationary and secured on the tabletop.

The rotary cutter 140 also optionally includes a safety cover, and safety mechanism to prevent blade rotation if and when holding bar 122 is not in a downward position. This safety mechanism can optionally prevent traveling of the rotary cutter 140 along the carriage (not shown) if and when holding bar 122 is not in a down position. Such safety mechanism can appropriately include mechanical and electrical sensors, and can include a microprocessor.

Automation of the system can be effectuated by providing a master control panel 160 electronically coupled to various elements of the system 100 to remotely control at least linear actuator 150, rotary cutter 140, and retaining mechanism 120. The master control panel 160 can control each element of the system independently upon user instruction. Thus the user can control the operation each of these elements independently. For example, a user can independently control each of the following actions: turning on the rotary cutter 140; moving the cutter forward in a distal direction; stopping the cutter; reversing travel direction; and, returning the cutter to the starting position.

Another embodiment of the current invention provides a semi-automatic control where a user can enter data into a master control panel 160 having a microprocessor. The user enters data with respect to desired cutting length. In response to the data entered, the microprocessor calculates and initiates a sequence of actions which includes securing woven blinds onto the table by moving holding bar 122 downward; turning on rotary cutter 140; moving rotary cutter 140 in a distal direction using the linear actuator; and, upon completion of cutting, turning off the rotary cutter; moving holding bar 122 in an upward direction. One of ordinary skill in the art will appreciate other possibilities of action sequences to achieve the intended goal of securing and cutting woven blind 130.

For example, a user sets up a woven blind on the tabletop. The user then selects material type and enters length of woven material into the controller of the system. In response, the microprocessor selects appropriate rotary cutter motor speed and engages holding bar 122. Holding bar 122 moves to a down position. The system begins cutting by moving the rotary cutter 140 from an initial position in a distal direction. The cutter 140 stops at a distal position when the cutter has traveled the length entered by the user. The motor of the rotary cutter 140 stops and linear actuator 150 moves rotary cutter 140 back to the initial position. Once the rotary cutter 140 has returned to the initial position, holding bar 122 moves to an upward position.

System 100 can have an alignment mechanism 170. In FIG. 1, alignment mechanism is a laser pointer. An example of suitable laser pointers include Craftsman Laser Trac™. In operation, woven blind 130 is first placed on table 110 with slats placed along a horizontal direction 132 of the tabletop. The user manually positions woven blind 130 on table 110 by aligning vertically running threads of the woven blind with the visible laser light beam emitted onto the woven blind 130 in a vertical direction. Once the vertically running threads of woven blind 130 is aligned, or made parallel with the laser light beam, holding bar 122 is lowered to secure woven blind 130 in place.

System 100 also has a fence guide 180 to square and position woven blind for cutting. Fence guide 180 slides across tabletop bi-directionally 182 on two linear rails. In operation, woven blind 130 is first positioned on the table without the help of fence guide 180. A user aligns the woven blind 130 using laser pointer 170. After one end of the slats is cut, the user flips the woven blind 130 over to prepare cutting of the opposite end. In preparing to cut the opposite end, the user need not use laser pointer 170 for alignment purposes. Instead, the user can align the woven blind using fence guide 180 by first abutting the freshly cut end of the woven blind 130 against the fence guide 180. Fence guide 180 can optionally include a handle and a fence guide lock, to lock fence guide 180 into a desirable position.

The present system 100 also features a trough 120 coupled to the table 110. Trough 120 can be any size and shape suitable to receive severed portions, or trimmings, of woven blinds 130.

Thus, specific embodiments and applications of systems and methods of cutting woven blinds have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A cutting device that cuts woven blinds, the cutting device comprises:
a table;
a rotary cutter having a knife blade;
a carriage coupled to the table and supports the rotary cutter;
a movable holding bar configured to hold a woven work piece against the table;
a linear actuator mechanism operatively coupled to the rotary cutter; and
wherein the linear actuator mechanism is capable of driving the rotary cutter to travel along the carriage.

2. The cutting device of claim 1, wherein the woven work piece is a woven blind having substantially parallel elements coupled to each other by retaining threads such that the blind has sufficient flexibility to allow distortion of the blind into a trapezoidal structure from a rectangular structure by displacement of parallel elements relative to each other.

3. The cutting device of claim 2, wherein the rotary cutter generates a force on the woven blind, and wherein the holding bar is configured to counteract the force such that the force would otherwise result in uneven cutting due to relative shifting of parallel elements.

4. The cutting device of claim 3, wherein the holding bar has a holding surface, the holding surface has a length configured to bias against at least 80% of the parallel elements in the woven blind, and wherein the holding surface has a width capable of counteracting the force.

5. The cutting device of claim 4, wherein the holding surface has a width of at least three centimeters.

6. The cutting device of claim 2, wherein the parallel elements includes at least one member selected from the group consisting of jute, wood, bamboo, rattan, reeds, fabric, and vinyl.

7. The cutting device of claim 5 wherein the linear actuator mechanism is a screw drive mechanism having a rotatable, threaded rod disposed parallel to the carriage, and wherein rotation of the threaded rod moves the rotary cutter in a distal direction by engaging with the treaded rod with a mating block.

8. The cutting device of claim 5 wherein the linear actuator mechanism is a belt drive mechanism having a movable belt disposed parallel to the carriage, and wherein movement of the belt moves the rotary cutter in a distal direction.

9. The cutting device of claim 6 further comprising:
a fence guide that is adjustably movable in a direction perpendicular to a longitudinal axis of the carriage;
a laser alignment guide to produce a visible line of light on the woven blinds, wherein the line of light is parallel to the carriage; and
a trough coupled to the table and underneath a path of the rotary cutter.

10. The cutting device of claim 6, wherein the movable holding bar is driven by at least one of electric force, hydraulic force, manual force, and pneumatic force.

11. The cutting device of claim 6 further comprising a microprocessor capable of receiving a user input to automatically operate the rotary cutter, the holding bar, and the linear actuator to cut the woven blind to a desired width.

12. A woven blinds cutting system comprising:
a table;
a movable retaining bar coupled to the table;
a rotary cutting tool capable of traveling across a section of the table and exerting a force;
a sheet material to be retained on the table by the movable retaining bar and cut by the rotary cutting tool;
wherein the sheet material has longitudinal elements coupled and substantially parallel to each other in ways to allow sufficient flexibility for movement of each longitudinal element against each other;
wherein the multi-directional movement of longitudinal elements allows contortion of the sheet material due to the force, from a substantially flat rectangular configuration to at least one configuration selected from the group consisting of wavy, trapezoidal, and twisted; and
wherein the retaining bar has a holding surface capable of biasing the sheet material against the table in a greater or equal counterforce to counteract the force and to minimize the contortion.

13. The cutting device of claim 12, wherein the sheet material is comprised of no more than 100 longitudinal elements woven together for every inch in a vertical direction.

14. The cutting device of claim 13, wherein the sheet material is a woven blind and the longitudinal elements includes at least one member selected from the group consisting of jute, wood, bamboo, rattan, reeds, fabric, and vinyl.

15. The cutting device of claim 13 further comprising a circular knife blade, a blade sharpener, and a blade cooling device operatively coupled to the rotary cutting tool.

16. The cutting device of claim 14, wherein the holding surface is capable of holding the woven blind in position to complete a full cut by the cutting tool to create a straight edge with less than 5% frayed edges, and wherein the holding surface has a width of at least three centimeters.

17. The cutting device of claim 14 further comprising a safety mechanism including sensors wherein the cutting tool is prevented from operating when the retaining bar is not in a down position.

18. The cutting device of claim 14 further comprising a safety mechanism having sensors to begin reducing a traveling speed of the cutting tool when the cutting tool is within five centimeter to 100 centimeter range from a desired stopping position, and wherein a pre-set maximum travel distance is provided such that the cutting tool stops traveling once the cutting tool reaches the maximum travel distance.

19. A method of cutting a woven blind to desired width using the cutting device of claim 11, the method comprising:
a user enters a data regarding desired cutting length into the microprocessor;
the user enters a command for cutting to begin;
the microprocessor turns on the rotary cutter;
the microprocessor initiates movement of the holding bar in a downward direction to hold the woven blind against the table;
the microprocessor turns on the linear actuator mechanism to move the rotary cutter in a distal direction traveling a distance longer or equal to the desired cutting length, to cut the woven blind;
the microprocessor turns off the linear actuator and the rotary cutter after the desired cut is performed; and
the microprocessor initiates movement of the holding bar in an upward direction to disengage the holding surface from the woven blind.
